(19) United States
(12) Patent Application Publication
(10) Pub. No.: US 2026/0104594 A1
(43) Pub. Date: Apr. 16, 2026

(54) VIRTUAL REALITY DISPLAY SUN DAMAGE PROTECTION

(71) Applicant: Meta Platforms Technologies, LLC, Menlo Park, CA (US)

(72) Inventors: Jie XIANG, San Jose, CA (US); Agnes LEE, Da'an (TW); Jun JIANG, Woodinville, WA (US)

(21) Appl. No.: 18/912,454

(22) Filed: Oct. 10, 2024

(51) Int. Cl. G02B 27/01

(52) U.S. Cl. CPC G02B 27/0179; G02B 27/0172; G02B 2027/0178; G02B 2027/0187

(57) ABSTRACT

A near-eye display comprises a display panel (e.g., a liquid crystal display (LCD) panel, an organic light emitting diode (OLED) display panel, or a light emitting diode (LED) display panel) configured to generate a display image, display optics configured to project the display image to a user, and an color filter or an electrically switchable layer on or near the display optics. The transmission spectra of the color filter match the light emission spectra of the display panel such that the color filter may transmit display light while blocking light outside of the passbands. The electrically switchable layer can be turned on to transmit display light and can be turned off to block ambient light.

### BACKGROUND

An artificial reality system, such as a head-mounted display (HMD) or heads-up display (HUD) system, generally includes a near-eye display system in the form of a headset or a pair of glasses and configured to present content to a user via an electronic or optic display within, for example, about 10-20 mm in front of the user's eyes. The near-eye display system may display virtual objects or combine images of real objects with virtual objects, as in virtual reality (VR), augmented reality (AR), or mixed reality (MR) applications. A near-eye display generally includes an optical system configured to form an image of a computer-generated image on an image plane. The optical system of the near-eye display may relay the image generated by an image source (e.g., a display panel) to create a virtual image that appears to be away from the image source and further than just a few centimeters away from the user's eyes.

### SUMMARY

This disclosure relates generally to near-eye display systems. More specifically, and without limitation, techniques disclosed herein relate to mitigating potential damages to near-eye display systems (e.g., liquid crystal display-based near-eye display systems) caused by ambient light such as sunlight. Various inventive embodiments are described herein, including devices, systems, methods, structures, materials, processes, and the like.

According to certain embodiments, a near-eye display system may include a display panel configured to generate a display image, display optics configured to project the display image to a user's eye, and a color filter on a side of the display optics opposing the display panel, where transmission spectra of the color filter match light emission spectra of the display panel.

According to certain embodiments, a near-eye display system may include a display panel configured to generate a display image, display optics configured to project the display image to a user's eye, and a color filter between the display optics and the display panel, where transmission spectra of the color filter match light emission spectra of the display panel.

According to certain embodiments, a near-eye display system may include a display panel configured to generate a display image, display optics configured to project the display image to a user's eye, an electrically switchable layer on a side of the display optics opposing the display panel, or between the display optics and the display panel and at a distance from the display panel, and a controller configured to turn on or turn off the electrically switchable layer.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 is a simplified block diagram of an example of an artificial reality system environment including a near-eye display according to certain embodiments.

FIG. 2 is a perspective view of an example of a near-eye display in the form of a head-mounted display (HMD) device for implementing some of the examples disclosed herein.

FIG. 3 is a perspective view of an example of a near-eye display in the form of a pair of glasses for implementing some of the examples disclosed herein.

FIG. 4 is a cross-sectional view of an example of a near-eye display according to certain embodiments.

FIG. 5 illustrates an example of an optical system with a non-pupil forming configuration for a near-eye display device according to certain embodiments.

FIG. 6 illustrates an example of a liquid crystal display (LCD) panel.

FIG. 7 illustrates an example of a layer stack of an LCD panel.

FIG. 8 illustrates examples of damages to an LCD display panel of a near-eye display by ambient light.

FIG. 9A illustrates an example of a near-eye display including an absorptive color filter according to certain embodiments.

FIG. 9B illustrates another example of a near-eye display including an absorptive color filter according to certain embodiments.

FIG. 9C illustrates an example of the transmission spectra of the absorptive color filter of FIG. 9A or 9B.

FIG. 10A illustrates an example of a near-eye display including an reflective color filter) according to certain embodiments.

FIG. 10B illustrates an example of the transmission spectra of the reflective color filter of FIG. 10A.

FIGS. 11A and 11B illustrate an example of a near-eye display including an electrically switchable layer according to certain embodiments.

FIG. 12 is a simplified block diagram of an electronic system of an example of a near-eye display for implementing some examples disclosed herein.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

This disclosure relates generally to near-eye display systems. More specifically, and without limitation, techniques disclosed herein relate to mitigating potential damages to near-eye display systems (e.g., liquid crystal display-based near-eye display systems) caused by ambient light such as sunlight. Various inventive embodiments are described herein, including devices, systems, methods, structures, materials, processes, and the like.

Near-eye displays generally include display panels or other image sources, and display optics (e.g., lenses) that may project images generated by the display panels or other image sources to user's eyes. The display panels or other image sources may be implemented using, for example, liquid crystal display (LCD), organic light emitting diode (OLED) display, micro-OLED display, inorganic light emitting diode (ILED) display, quantum-dot light emitting diode (QLED) display, micro-light emitting diode (micro-LED) display, active-matrix OLED display (AMOLED), transparent OLED display (TOLED), and the like. It is generally desirable that the image source or the display panel of a near-eye display system has a higher resolution, a large color gamut, more pixels, and better image quality, in order to improve the immersive experience of using a near-eye display system. For a battery-powered near-eye display system, it may also be desirable that the system has a higher power efficiency to reduce power consumption and improve the battery life of the system. LCD panels may offer many advantages over other display technologies, such as lower cost, longer lifetime, higher energy efficiencies, larger image sizes, and the like.

In some near-eye displays such as a virtual reality (VR) display, display optics may be between the user's eyes and the display panel during use, and may be positioned such that the display panel may be on or near the focal plane of the display optics. Therefore, the display optics may collimate light from the display panel to convert spatial information of the displayed images into angular information. As such, the display optics may relay the images to create virtual images that appear to be far away from the display panel, such as much further than just a few centimeters away from the eyes of the user. The lens of the user's eye may receive and focus the display light to form images on the retina of the user's eye.

When the near-eye display is not in use (e.g., not worn on a user's head), ambient light from the side of the display optics opposing the display panel may be focused onto the display panel by the display optics. For example, when the display optics of a VR display is facing a bright ambient light source such as the sun, ambient light (e.g., sunlight) may be focused onto the display panel by the display optics. The focused ambient light may have sufficiently high energy to cause permanent damages to components of the display panel (e.g., polarizers, thin films, coatings, liquid crystal cells, etc.), in particular, the component at the peak intensity, such as the front polarizer of a liquid crystal display panel that is used to transmit light in a particular polarization direction and at least partially block (e.g., absorb or reflect) light in other polarization directions. Similar damages may occur in VR displays that include display optics and other types of display panels, such as micro-OLED display panels or micro-LED display panels.

According to certain embodiments disclosed herein, at least a portion of the ambient light may be blocked (e.g., absorbed, reflected, or scattered) by a color filter or a light dimming element before it may be focused onto the display panel by the display optics of a near-eye display to form a local hot spot having a high energy in a small area, which otherwise could cause damages to components of the near-eye display, such as a front polarizer of an LCD display panel of the near-eye display. The color filter or light dimming element may have minimum or no effect on the viewing of the displayed images by the user during normal use of the near-eye display. For example, the ambient light may be blocked by bandpass filters that may block light outside of the light emission spectra of the display panel, or may be blocked by electrically switchable layers that may be switched off to block light when the near-eye display is not in use and may be switched on to allowed the display light to pass through when the near-eye display is in use.

In one example, a near-eye display system disclosed herein may include an absorptive color filter coated on a lens of the display optics or another substrate of the near-eye display system. The absorptive color filter may include multiple (e.g., three or more) passbands that match the wavelength bands of the light (e.g., red, green, and blue light) emitted by the image source (e.g., display panel) of the near-eye display. The absorptive color filter may only allow light in the passbands to pass through and may absorb light in other wavelength bands. In this way, display light from the image source of the near-eye display may pass through the absorptive color filter with little or no loss, while only a fraction (e.g., less than about 50%) of the ambient light may be allowed to pass through the absorptive color filter. Therefore, when the near-eye display is in use, most or all display light reaching the absorptive color filter from the image source may pass through the absorptive color filter to reach the user's eye. When the near-eye display is not in use, only a fraction of the light from the ambient environment may be focused by the display optics onto the display panel. The absorptive color filter can be formed on one or more (e.g., top and/or bottom) surfaces of the display optics (e.g., a lens such as a pancake lens or Fresnel lens) or another substrate. The absorptive color filter with multiple (e.g., three or more) passbands may be made by, for example, depositing chromatic or dye materials with different peak absorption wavelength ranges on one or more surfaces of a lens assembly. The chromatic or dye materials may be selected such that the transmission spectra of the absorptive color filter may match the light emission spectra of the image source (e.g., the display panel).

In another example, a near-eye display system disclosed herein may include a reflective color filter formed one or more surfaces of the display optics, another substrate, or a surface of the display panel. The reflective color filter may include multiple (e.g., three or more) passbands that match the wavelength bands of the light (e.g., red, green, and blue light) emitted by the display panel of the near-eye display. The reflective color filter may only allow light in the passbands to pass through and may reflect light in other wavelength bands. In this way, display light from the display panel may pass through the reflective color filter with little or no loss to reach the user's eye, while a large portion (e.g., greater than about 50%) of the ambient light may be reflected by the reflective color filter before or after the ambient light is focused by the display optics. Therefore, when the near-eye display is in use, most or all display light reaching the reflective color filter from the display panel may pass through the reflective color filter to reach the user's eye. When the near-eye display is not in use, only a fraction of the light from the ambient environment may pass through the reflective color filter and be focused by the display optics onto the display panel. The reflective color filter can be formed on one or more (e.g., top and/or bottom) surfaces of the display optics (e.g., a lens such as a pancake lens or a Fresnel lens), another substrate, or a surface of the display panel. The reflective color filter with multiple passbands may include, for example, a plurality of dielectric layers having different refractive indices and coated on one or more surfaces of the display optics (e.g., a lens assembly) or another substrate by, for example, vapor deposition or other coating or deposition techniques. The refractive indices and the thicknesses of the plurality of dielectric layers may be selected such that the transmission spectra of the reflective color filter may match the light emission spectra of the image source (e.g., display panel), so that the reflective color filter may not reflect display light from the image source.

In yet another example, a near-eye display disclosed herein may additionally or alternatively include one or more electrically switchable films formed on one or more surfaces of the display optics (e.g., a lens assembly) or another substrate. The electrically switchable films, when switched off, may reflect, absorb, and/or scatter incident light. When switched on (e.g., in a normal or default operation mode), the electrically switchable films may allow most or all display light to pass through and reach user's eye. When the near-eye display is not in use, the electrically switchable films may be switched off to reflect, absorb, and/or scatter most or all incident light (e.g., sunlight), thereby protecting the image source (e.g., display panel) from being damaged by ambient light. The one or more electrically switchable films may be formed on one or more (e.g., top and/or bottom) surfaces of the display optics (e.g., a lens such as a pancake lens) or another substrate. The one or more electrically switchable films may be a reflective film (e.g., including a cholesterol liquid crystal film), a light scattering film (e.g., including a polymer-dispersed liquid crystal film), a light absorption film (e.g., including a electrochromic film or a dye doped liquid crystal film). In some embodiments, the electrically switchable film may be normally on (e.g., when no voltage signal is applied) and may be turned off when a voltage signal is applied to the electrically switchable film. In some embodiments, the electrically switchable film may be normally off (e.g., when no voltage signal is applied) and may be turned on when a voltage signal is applied to the electrically switchable film. In some examples, a near-eye display may include a combination of the absorptive color filter, reflective color filter, and/or electrically switchable film.

Techniques described herein may be used in conjunction with various technologies, such as an artificial reality system. An artificial reality system, such as a head-mounted display (HMD) or heads-up display (HUD) system, generally includes a display configured to present artificial images that depict objects in a virtual environment. The display may present virtual objects or combine images of real objects with virtual objects, as in virtual reality (VR), augmented reality (AR), or mixed reality (MR) applications. For example, in an AR system, a user may view both displayed images of virtual objects (e.g., computer-generated images (CGIs)) and the surrounding environment by, for example, seeing through transparent display glasses or lenses (often referred to as optical see-through) or viewing displayed images of the surrounding environment captured by a camera (often referred to as video see-through).

In the following description, for the purposes of explanation, specific details are set forth in order to provide a thorough understanding of examples of the disclosure. However, it will be apparent that myriad examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

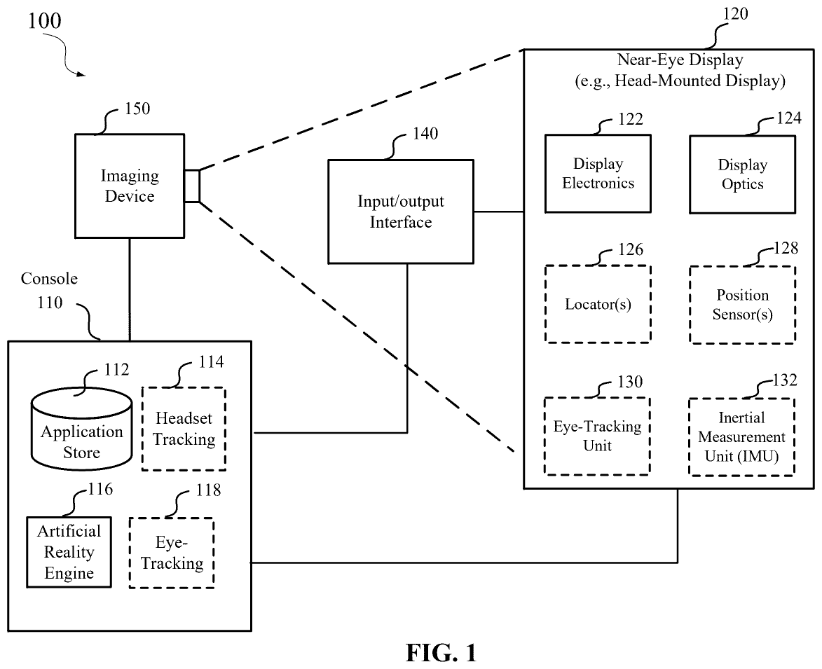

FIG. 1 is a simplified block diagram of an example of an artificial reality system environment 100 including a near-eye display 120 in accordance with certain embodiments. Artificial reality system environment 100 shown in FIG. 1 may include near-eye display 120, an optional external imaging device 150, and an optional input/output interface 140, each of which may be coupled to an optional console 110. While FIG. 1 shows an example of artificial reality system environment 100 including one near-eye display 120, one external imaging device 150, and one input/output interface 140, any number of these components may be included in artificial reality system environment 100, or any of the components may be omitted. For example, there may be multiple near-eye displays 120 monitored by one or more external imaging devices 150 in communication with console 110. In some configurations, artificial reality system environment 100 may not include external imaging device 150, optional input/output interface 140, and optional console 110. In alternative configurations, different or additional components may be included in artificial reality system environment 100.

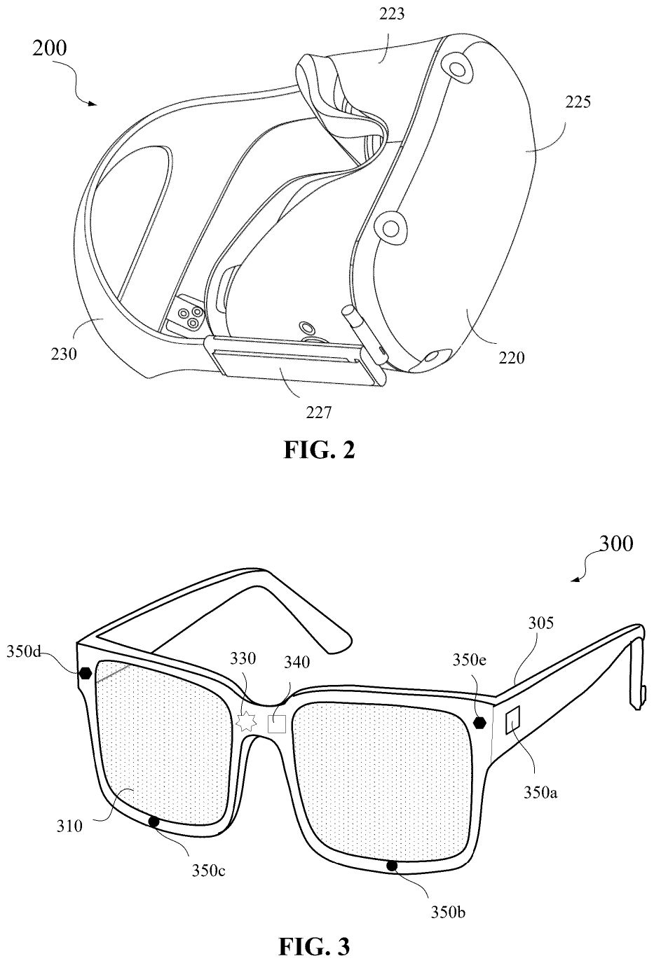

Near-eye display 120 may be a head-mounted display that presents content to a user. Examples of content presented by near-eye display 120 include one or more of images, videos, audio, or any combination thereof. In some embodiments, audio may be presented via an external device (e.g., speakers and/or headphones) that receives audio information from near-eye display 120, console 110, or both, and presents audio data based on the audio information. Near-eye display 120 may include one or more rigid bodies, which may be rigidly or non-rigidly coupled to each other. A rigid coupling between rigid bodies may cause the coupled rigid bodies to function as a single rigid entity. A non-rigid coupling between rigid bodies may allow the rigid bodies to move relative to each other. In various embodiments, near-eye display 120 may be implemented in any suitable form-factor, including a pair of glasses. Some embodiments of near-eye display 120 are further described below with respect to FIGS. 2 and 3. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, sound, etc.) to present an augmented reality to a user.

In various embodiments, near-eye display 120 may include one or more of display electronics 122, display optics 124, and an eye-tracking unit 130. In some embodiments, near-eye display 120 may also include one or more locators 126, one or more position sensors 128, and an inertial measurement unit (IMU) 132. Near-eye display 120 may omit any of eye-tracking unit 130, locators 126, position sensors 128, and IMU 132, or include additional elements in various embodiments. Additionally, in some embodiments, near-eye display 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (μLED) display, an active-matrix OLED display (AMOLED), a transparent OLED display (TOLED), or some other display. For example, in one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereoscopic effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers) or magnify image light received from display electronics 122, correct optical errors associated with the image light, and present the corrected image light to a user of near-eye display 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an antireflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124. In some embodiments, display optics 124 may project displayed images to one or more image planes that may be further away from the user's eyes than near-eye display 120.

Display optics 124 may also be designed to correct one or more types of optical errors, such as two-dimensional optical errors, three-dimensional optical errors, or any combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display 120 relative to one another and relative to a reference point on near-eye display 120. In some implementations, console 110 may identify locators 126 in images captured by external imaging device 150 to determine the artificial reality headset's position, orientation, or both. A locator 126 may be a light emitting diode (LED), a corner cube reflector, a reflective marker, a type of light source that contrasts with an environment in which near-eye display 120 operates, or any combination thereof. In embodiments where locators 126 are active components (e.g., LEDs or other types of light emitting devices), locators 126 may emit light in the visible band (e.g., about 380 nm to 750 nm), in the infrared (IR) band (e.g., about 750 nm to 1 mm), in the ultraviolet band (e.g., about 12 nm to about 380 nm), in another portion of the electromagnetic spectrum, or in any combination of portions of the electromagnetic spectrum.

External imaging device 150 may include one or more cameras, one or more video cameras, any other device capable of capturing images including one or more of locators 126, or any combination thereof. Additionally, external imaging device 150 may include one or more filters (e.g., to increase signal to noise ratio). External imaging device 150 may be configured to detect light emitted or reflected from locators 126 in a field of view of external imaging device 150. In embodiments where locators 126 include passive elements (e.g., retroreflectors), external imaging device 150 may include a light source that illuminates some or all of locators 126, which may retro-reflect the light to the light source in external imaging device 150. Slow calibration data may be communicated from external imaging device 150 to console 110, and external imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display 120. Examples of position sensors 128 may include accelerometers, gyroscopes, magnetometers, other motion-detecting or error-correcting sensors, or any combination thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or any combination thereof. Based on the one or more measurement signals from one or more position sensors 128, IMU 132 may generate fast calibration data indicating an estimated position of near-eye display 120 relative to an initial position of near-eye display 120. For example, IMU 132 may integrate measurement signals received from accelerometers over time to estimate a velocity vector and integrate the velocity vector over time to determine an estimated position of a reference point on near-eye display 120. Alternatively, IMU 132 may provide the sampled measurement signals to console 110, which may determine the fast calibration data. While the reference point may generally be defined as a point in space, in various embodiments, the reference point may also be defined as a point within near-eye display 120 (e.g., a center of IMU 132).

Eye-tracking unit 130 may include one or more eye-tracking systems. Eye tracking may refer to determining an eye's position, including orientation and location of the eye, relative to near-eye display 120. An eye-tracking system may include an imaging system to image one or more eyes and may optionally include a light emitter, which may generate light that is directed to an eye such that light reflected by the eye may be captured by the imaging system. For example, eye-tracking unit 130 may include a non-coherent or coherent light source (e.g., a laser diode) emitting light in the visible spectrum or infrared spectrum, and a camera capturing the light reflected by the user's eye. As another example, eye-tracking unit 130 may capture reflected radio waves emitted by a miniature radar unit. Eye-tracking unit 130 may use low-power light emitters that emit light at frequencies and intensities that would not injure the eye or cause physical discomfort. Eye-tracking unit 130 may be arranged to increase contrast in images of an eye captured by eye-tracking unit 130 while reducing the overall power consumed by eye-tracking unit 130 (e.g., reducing power consumed by a light emitter and an imaging system included in eye-tracking unit 130). For example, in some implementations, eye-tracking unit 130 may consume less than 120 milliwatts of power.

Near-eye display 120 may use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or any combination thereof. Because the orientation may be determined for both eyes of the user, eye-tracking unit 130 may be able to determine where the user is looking. For example, determining a direction of a user's gaze may include determining a point of convergence based on the determined orientations of the user's left and right eyes. A point of convergence may be the point where the two foveal axes of the user's eyes intersect. The direction of the user's gaze may be the direction of a line passing through the point of convergence and the mid-point between the pupils of the user's eyes.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface 140 may provide haptic feedback when an action request is received, or when console 110 has performed a requested action and communicates instructions to input/output interface 140. In some embodiments, external imaging device 150 may be used to track input/output interface 140, such as tracking the location or position of a controller (which may include, for example, an IR light source) or a hand of the user to determine the motion of the user. In some embodiments, near-eye display 120 may include one or more imaging devices to track input/output interface 140, such as tracking the location or position of a controller or a hand of the user to determine the motion of the user.

Console 110 may provide content to near-eye display 120 for presentation to the user in accordance with information received from one or more of external imaging device 150, near-eye display 120, and input/output interface 140. In the example shown in FIG. 1, console 110 may include an application store 112, a headset tracking subsystem 114, an artificial reality engine 116, and an eye-tracking subsystem 118. Some embodiments of console 110 may include different or additional devices or subsystems than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In various embodiments, the devices or subsystems of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking subsystem 114 may track movements of near-eye display 120 using slow calibration information from external imaging device 150. For example, headset tracking subsystem 114 may determine positions of a reference point of near-eye display 120 using observed locators from the slow calibration information and a model of near-eye display 120. Headset tracking subsystem 114 may also determine positions of a reference point of near-eye display 120 using position information from the fast calibration information. Additionally, in some embodiments, headset tracking subsystem 114 may use portions of the fast calibration information, the slow calibration information, or any combination thereof, to predict a future location of near-eye display 120. Headset tracking subsystem 114 may provide the estimated or predicted future position of near-eye display 120 to artificial reality engine 116.

Artificial reality engine 116 may execute applications within artificial reality system environment 100 and receive position information of near-eye display 120, acceleration information of near-eye display 120, velocity information of near-eye display 120, predicted future positions of near-eye display 120, or any combination thereof from headset tracking subsystem 114. Artificial reality engine 116 may also receive estimated eye position and orientation information from eye-tracking subsystem 118. Based on the received information, artificial reality engine 116 may determine content to provide to near-eye display 120 for presentation to the user. For example, if the received information indicates that the user has looked to the left, artificial reality engine 116 may generate content for near-eye display 120 that mirrors the user's eye movement in a virtual environment. Additionally, artificial reality engine 116 may perform an action within an application executing on console 110 in response to an action request received from input/output interface 140, and provide feedback to the user indicating that the action has been performed. The feedback may be visual or audible feedback via near-eye display 120 or haptic feedback via input/output interface 140.

Eye-tracking subsystem 118 may receive eye-tracking data from eye-tracking unit 130 and determine the position of the user's eye based on the eye tracking data. The position of the eye may include an eye's orientation, location, or both relative to near-eye display 120 or any element thereof. Because the eye's axes of rotation change as a function of the eye's location in its socket, determining the eye's location in its socket may allow eye-tracking subsystem 118 to more accurately determine the eye's orientation.

FIG. 2 is a perspective view of an example of a near-eye display in the form of an HMD device 200 for implementing some of the examples disclosed herein. HMD device 200 may be a part of, e.g., a VR system, an AR system, an MR system, or any combination thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temple tips as shown in, for example, FIG. 3 below, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audio, or any combination thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, an LCD, an OLED display, an ILED display, a μLED display, an AMOLED, a TOLED, some other display, or any combination thereof. HMD device 200 may include two eye box regions.

In some implementations, HMD device 200 may include various sensors (not shown), such as depth sensors, motion sensors, position sensors, and eye tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or any combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

FIG. 3 is a perspective view of an example of a near-eye display 300 in the form of a pair of glasses for implementing some of the examples disclosed herein. Near-eye display 300 may be a specific implementation of near-eye display 120 of FIG. 1, and may be configured to operate as a virtual reality display, an augmented reality display, and/or a mixed reality display. Near-eye display 300 may include a frame 305 and a display 310. Display 310 may be configured to present content to a user. In some embodiments, display 310 may include display electronics and/or display optics. For example, as described above with respect to near-eye display 120 of FIG. 1, display 310 may include an LCD panel, an LED display panel, or an optical display panel (e.g., a waveguide display assembly).

Near-eye display 300 may further include various sensors 350a, 350b, 350c, 350d, and 350e on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display 300, and/or to provide an interactive VR/AR/MR experience to a user of near-eye display 300. In some embodiments, sensors 350a-350e may also be used for stereoscopic imaging.

In some embodiments, near-eye display 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light patterns onto the objects within the environment. In some embodiments, illuminator(s) 330 may be used as locators, such as locators 126 described above with respect to FIG. 1.

In some embodiments, near-eye display 300 may also include a high-resolution camera 340. High-resolution camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

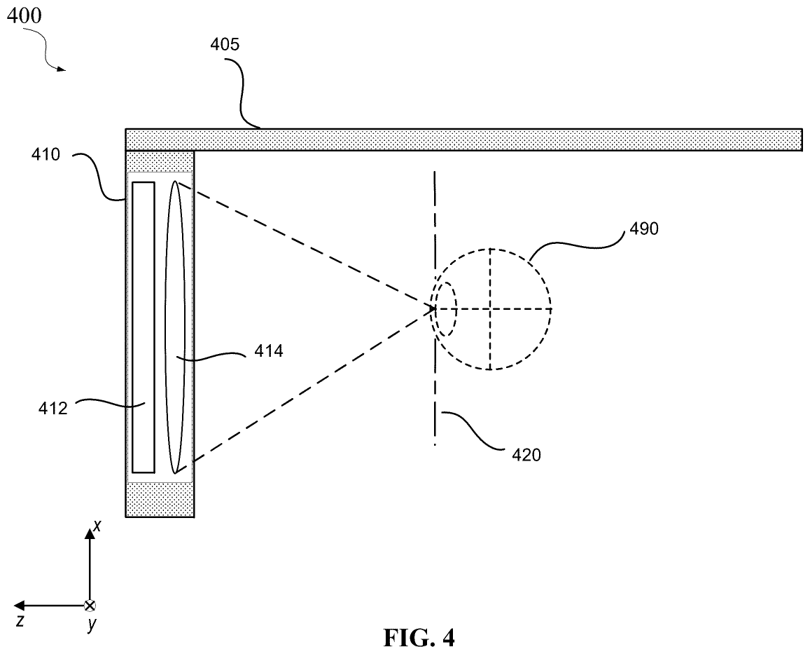

FIG. 4 is a cross-sectional view of an example of a near-eye display 400 according to certain embodiments. Near-eye display 400 may include at least one display assembly 410. Display assembly 410 may be configured to direct image light (e.g., display light) to an eyebox located at an exit pupil 420 and to user's eye 490. It is noted that, even though FIG. 4 and other figures in the present disclosure show an eye of a user of the near-eye display for illustration purposes, the eye of the user is not a part of the corresponding near-eye display.

As HMD device 200 and near-eye display 300, near-eye display 400 may include a frame 405 and display assembly 410 that may include a display 412 and/or display optics 414 coupled to or embedded in frame 405. As described above, display 412 may display images to the user electrically (e.g., using LCDs, LEDs, OLEDs) or optically (e.g., using a waveguide display and optical couplers) according to data received from a processing unit, such as console 110. In some embodiments, display 412 may include a display panel that includes pixels made of LCDs, LEDs, OLEDs, and the like. Display 412 may include sub-pixels to emit light of a predominant color, such as red, green, blue, white, or yellow. In some embodiments, display assembly 410 may include a stack of one or more waveguide displays including, but not restricted to, a stacked waveguide display, a varifocal waveguide display, and the like. The stacked waveguide display may be a polychromatic display (e.g., a red-green-blue (RGB) display) created by stacking waveguide displays whose respective monochromatic sources are of different colors.

Display optics 414 may be similar to display optics 124 and may display image content optically (e.g., using optical waveguides and optical couplers), correct optical errors associated with the image light, combine images of virtual objects and real objects, and present the corrected image light to exit pupil 420 of near-eye display 400, where the user's eye 490 may be located. In some embodiments, display optics 414 may also relay the images to create virtual images that appear to be away from display 412 and further than just a few centimeters away from the eyes of the user. For example, display optics 414 may collimate the image source to create a virtual image that may appear to be far away (e.g., greater than about 0.3 m, such as about 0.5 m, 1 m, or 3 m away) and convert spatial information of the displayed virtual objects into angular information. In some embodiments, display optics 414 may also magnify the source image to make the image appear larger than the actual size of the source image. More details of display 412 and display optics 414 are described below.

In various implementations, the optical system of a near-eye display, such as an HMD, may be pupil-forming or non-pupil-forming. Non-pupil-forming HMDs may not use intermediary optics to relay the displayed image, and thus the user's pupils may serve as the pupils of the HMD. Such non-pupil-forming displays may be variations of a magnifier (sometimes referred to as “simple eyepiece”), which may magnify a displayed image to form a virtual image at a greater distance from the eye. The non-pupil-forming display may use fewer optical elements. Pupil-forming HMDs may use optics similar to, for example, optics of a compound microscope or telescope, and may include some forms of projection optics that magnify an image and relay it to the exit pupil.

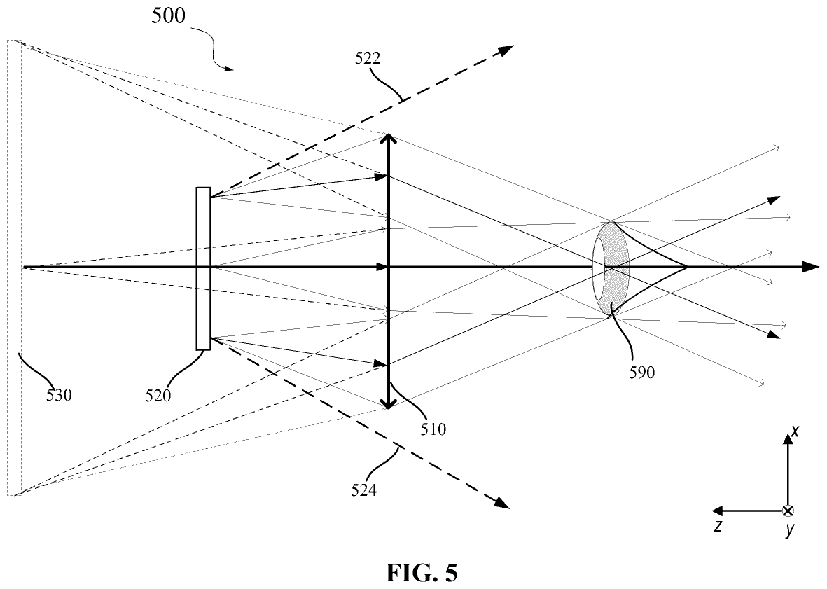

FIG. 5 illustrates an example of an optical system 500 with a non-pupil forming configuration for a near-eye display device according to certain embodiments. Optical system 500 may be an example of near-eye display 400, and may include display optics 510 and an image source 520 (e.g., a display panel). Display optics 510 may function as a magnifier. FIG. 5 shows that image source 520 is in front of display optics 510. In some other embodiments, image source 520 may be located outside of the field of view of the user's eye 590. For example, one or more deflectors or directional couplers may be used to deflect light from an image source to make the image source appear to be at the location of image source 520 shown in FIG. 5. Image source 520 may be an example of display 412 described above. For example, image source 520 may include a two-dimensional array of light emitters, such as semiconductor micro-LEDs or micro-OLEDs. The dimensions and pitches of the light emitters in image source 520 may be small. For example, each light emitter may have a diameter less than 2 μm (e.g., about 1.2 μm) and the pitch may be less than 2 μm (e.g., about 1.5 μm). As such, the number of light emitters in image source 520 can be equal to or greater than the number of pixels in a display image, such as 960×720, 1280×720, 1440×1080, 1920×1080, 2160×1080, 2560×1080, or even more pixels. Thus, a display image may be generated simultaneously by image source 520.

Light from an area (e.g., a pixel or a light emitter) of image source 520 may be directed to a user's eye 590 by display optics 510. Light directed by display optics 510 may form virtual images on an image plane 530. The location of image plane 530 may be determined based on the location of image source 520 and the focal length of display optics 510. A user's eye 590 may form a real image on the retina of user's eye 590 using light directed by display optics 510. In this way, objects at different spatial locations on image source 520 may appear to be objects on an image plane far away from user's eye 590 at different viewing angles. Image source 520 may have a size larger or smaller than the size (e.g., aperture) of display optics 510. Some light emitted from image source 520 with large emission angles (as shown by light rays 522 and 524) may not be collected and directed to user's eye 590 by display optics 510, and may become stray light.

The display panels or image sources described above (e.g., display 412 or image source 520) may be implemented using, for example, a liquid crystal display (LCD), an organic light emitting diode (OLED) display, a micro-OLED display, an inorganic light emitting diode (ILED) display, a micro-light emitting diode (micro-LED) display, an active-matrix OLED display (AMOLED), a transparent OLED display (TOLED), or some other displays. In a near-eye display system, it is generally desirable that the image source or the display panel has a higher resolution and a large size, such that the near-eye display system may have a large field of view (FOV) and better image quality to, for example, improve the immersive experience of using the near-eye display system. The FOV of a display system is the angular range over which an image may be projected in the near or far field. The FOV of a display system is generally measured in degrees, and the resolution over the FOV is generally measured in pixels per degree (PPD). The FOV of a display system may be linearly proportional to the size of the image source (e.g., the display panel), and may be inversely proportional to the focal length of the display optics (e.g., a collimation lens or lens assembly). A balance between the size of the image source and the optical power of the display optics may be needed in order to achieve a good modulation transfer function (MTF) and reduced size/weight/cost. The field of view may be increased by bringing the image source closer, but the image source would need to have higher PPD, and the aberrations of the display optics at the periphery may limit the effective field of view. To achieve a high PPD, micro displays with ultra-high pixels per inch (PPI) may be needed. There may be many technological challenges and cost issues associated with making high-PPI display panels, such as high resolution LCD panels.

Many consumer virtual reality (VR) near-eye display systems use LCD panels to generate the displayed images. LCD panels for VR applications typically operate in a transmissive mode, where light may be modulated while being transmitted by the LCD panels. For example, a transmissive LCD panel may include a backlight unit (BLU) and a liquid crystal (LC) panel that may modulate and filter light from the BLU at individual pixels. The LC panel may include a liquid crystal cell sandwiched by a bottom (or back) substrate and a top (or front) substrate. In some implementations, the bottom substrate may include thin-film transistor (TFT) circuits formed on a glass substrate for controlling the liquid crystal cell, whereas the top substrate may include a common electrode and an array of color filters formed thereon. In some implementations, the bottom substrate may include both TFT circuits and an array of color filters formed on a glass substrate (referred to as color filter on array (COA)), whereas the top substrate may include a common electrode and a black matrix formed thereon. In some implementations, pixel electrodes and the common electrode may both be formed on the bottom substrate, for example, in fringe field switching (FFS) mode liquid crystal display, whereas the top substrate may include a black matrix and an overcoat layer formed thereon.

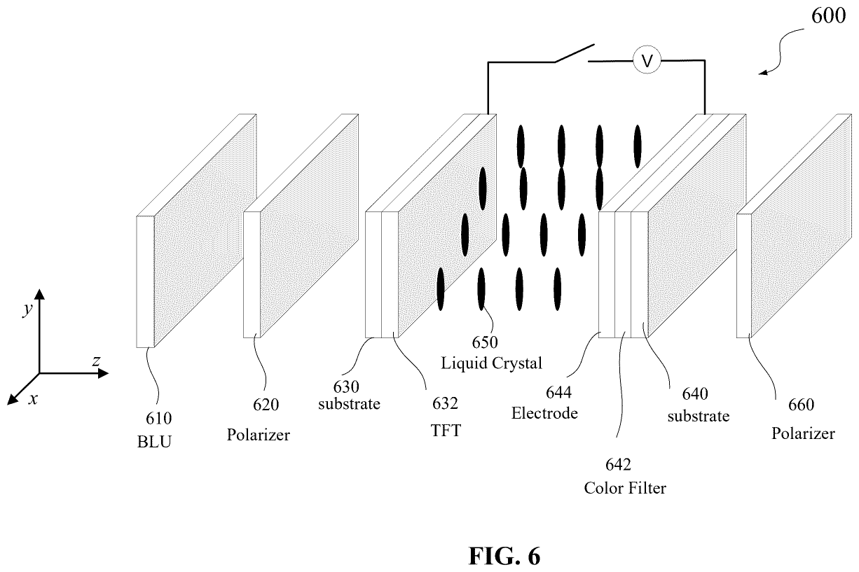

FIG. 6 illustrates an example of an LCD panel 600. As illustrated, LCD panel 600 may include a backlight unit (BLU) 610 configured to emit illumination light, a first polarizer 620 configured to control the type of light that can pass through (e.g., based on the polarization state of the light), an LCD cell that may modulate (e.g., the phase or polarization state of) the incident light, and a second polarizer 660 for control the type of light that can pass through (e.g., based on the polarization state of the light). In some embodiments, BLU 610 may include a light source (e.g., a cold-cathode fluorescent lamp) configured to emit white light. In some embodiments, BLU 610 may include blue light emitting LEDs, a light guide plate, and a quantum dot film that includes quantum dots for converting some blue light to red light and green light.

In the illustrated example, the LCD cell may include a first substrate 630 (e.g., a glass substrate or another transparent dielectric substrate) including a thin-film transistor (TFT) array 632 formed thereon. TFT array 632 may include an array of transistors for controlling the intensity of each pixel (e.g., by controlling the orientations of the liquid crystal molecules in a liquid crystal layer, thereby controlling the rotation angle of the polarization direction of the incident light). The LCD cell may also include a second substrate 640 with a common electrode 644 and a color filter (CF) /black-matrix (BM) array 642 formed thereon. One or more liquid crystal layers 650 may be sandwiched by first substrate 630 and second substrate 640.

In some other implementations, first substrate 630 may include both TFT array 632 and color filters formed on TFT array 632 to form a color filter on array (COA) structure, whereas the top substrate may include a common electrode and a black matrix formed on another glass substrate. The COA structure may enable a simplified process, improved aperture ratio, and reduced production cost. In some implementations, the LCD cell may be a fringe field switching (FFS) mode LCD cell, where the pixel electrodes and the common electrode may both be formed on the bottom substrate, and the top substate may include a black matrix and an overcoat layer formed thereon.

Light emitted by BLU 610 (e.g., white light or blue light) may be polarized by first polarizer 620 (e.g., a linear polarizer with a polarizing axis in a first direction). The polarized light may pass through an array of apertures between the TFTs in TFT array 632. The polarized light may be modulated by the one or more liquid crystal layers 650 to change the polarization state (e.g., the polarization direction) according to the voltage signal applied to each region of the one or more liquid crystal layers 650. CF/BM array 642 may include red, green, and blue color filters, where each color filter may allow light of one color to pass through. Light passing through each color filter may become a subpixel of a color image pixel that may include three subpixels, and may be filtered by second polarizer 660 such that the change in the polarization state may be converted into a change in the light intensity or brightness. For example, second polarizer 660 may include a linear polarizer with a polarizing axis in a second direction that may be the same as or different from the first direction. The transmission axis of first polarizer 620 may be aligned with the transmission axis of second polarizer 660.

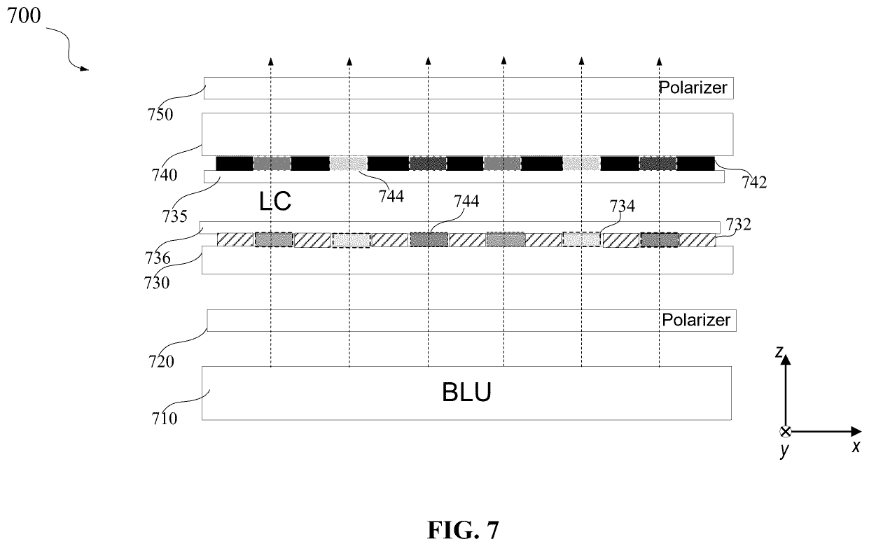

FIG. 7 illustrates an example of a layer stack of an LCD panel 700. LCD panel 700 may be an example of LCD panel 600. In the illustrated example, LCD panel 700 may include a BLU 710, a first polarizer 720, a first substrate 730 including a TFT array and/or black-mask 732 and an array of apertures 734 formed thereon, a common electrode layer 735, a second substrate 740 with a CF/BM array including a black-matrix layer 742 and optionally an array of color filters 744 in black-matrix layer 742, and a second polarizer 750. BLU 710 may be similar to BLU 610 described above. TFT array and/or black-mask 732 may include TFT circuits (e.g., TFTs, gate electrodes, source electrodes, etc.) for controlling liquid crystal molecules filled between first substrate 730 and second substrate 740. Common electrode layer 735 may include a transparent conductive oxide (TCO), such as indium tin oxide (ITO). Color filters 744 may include red, green, and blue color filters. Centers of color filters 744 may align with corresponding centers of apertures 734 on first substrate 730, such that light from BLU 710 and first polarizer 720 may pass through apertures 734 and color filters 744. Second polarizer 750 may include a linear polarizer with a polarizing axis in a direction that is different from or same as the direction of the polarizing axis of first polarizer 720. For example, the direction of the polarizing axis of first polarizer 720 may be orthogonal to the direction of the polarizing axis of second polarizer 750. First polarizer 720 and second polarizer 750 may be used in combination to convert the change in the polarization state (e.g., polarization direction) by the liquid crystal layer to change in the light intensity so as to display images to user's eyes.

As described above with respect to FIG. 6, in some implementations, instead of forming color filters 744 on a separate substrate, color filters 744 may be formed on first substrate 730 (e.g., between TFT array and/or black-mask 732) to form a COA structure. In some implementations, the LCD cell may be an FFS mode LCD cell, where both the pixel electrodes and the common electrode may be formed on first substrate 730 that includes the TFT array and/or black-mask 732 . In other implementations, the TFT array, the color filters, the black matrix, and the electrodes may be arranged in other manners on the two substates that sandwich the liquid crystal material.

Even though not shown in FIG. 7, spacers (e.g., plastic spacers) may be used between TFT array and/or black-mask 732 and common electrode layer 735 to separate TFT array and/or black-mask 732 and common electrode layer 735 so that liquid crystal materials may be filled between TFT array and/or black-mask 732 (or a protective or planarization layer 736) and common electrode layer 735 to modulate incident light. For example, TFT array and/or black-mask 732 may include column spacers formed thereon (e.g., on top of source electrodes), and the CF/BM array (or black-matrix layer 742 or common electrode layer 735) may include photo spacers formed thereon. When first substrate 730 and second substrate 740 are assembled to form an LCD cell, photo spacers may sit on corresponding column spacers to achieve the desired separation between TFT array and/or black-mask 732 and the CF/BM array (or black-matrix layer 742 or common electrode layer 735).

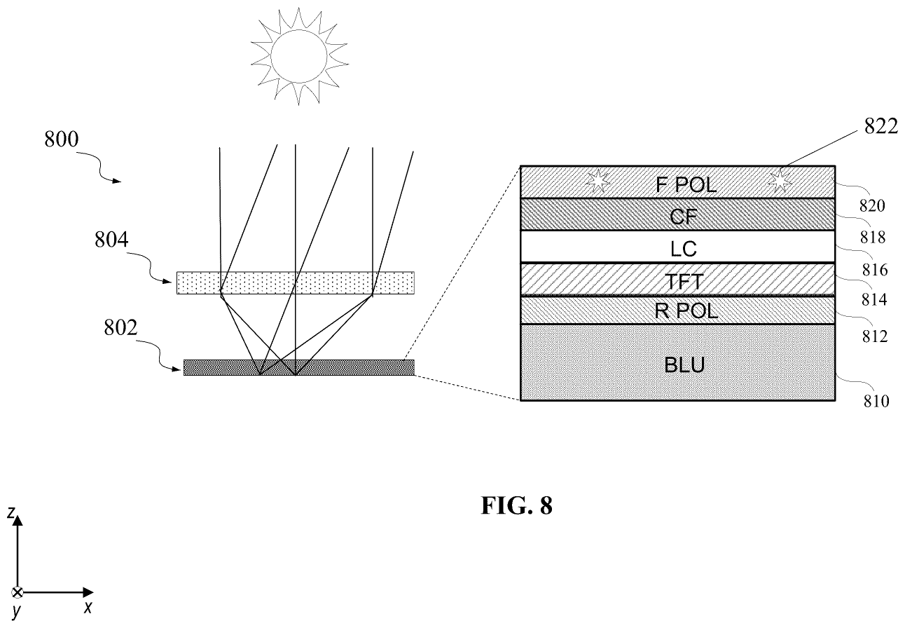

FIG. 8 illustrates examples of damages to an LCD display panel of a near-eye display 800 (e.g., a VR display) by ambient light (e.g., sunlight). As described above with respect to, for example, FIGS. 4 and 5, near-eye display 800 may include a display panel 802 and display optics 804. Display panel 802 may be at or near a focal plane of display optics 804, such that display optics 804 may collimate the light from each pixel of display panel 802 so that the image displayed by display panel 802 may appear to be further away from the actual location of display panel 802. In one example, display panel 802 may be an LCD display panel, such as LCD panel 600 or 700. The LCD display panel may include, for example, a backlight unit 810 (e.g., backlight unit 610 or 710), a rear polarizer 812 (e.g., first polarizer 620 or 720), a TFT layer 814, an LC cell 816, a color filter layer 818, and a front polarizer 820 (e.g., second polarizer 660 or 750), as described above with respect to, for example, FIGS. 6 and 7. In some other examples, display panel 802 may include an OLED based display panel or a micro-LED based display panel.

When near-eye display 800 is not in use, for example, when near-eye display 800 is placed on a table with display optics 804 facing an ambient light source such as the sun, display optics 804 may focus the sunlight to form a light spot on a small area of display panel 802 that may be at or near the focal plane of display optics 804. The light spot at the small area may have a high intensity. At front polarizer 820, the focused light spot may have the highest intensity and thus may damage (e.g., burn) front polarizer 820 due to, for example, high light absorption (e.g., about 50% for unpolarized light) by front polarizer 820 and heat accumulation at front polarizer 820. Depending on the relative location of the ambient light source with respect to near-eye display 800, the damaged portion 822 on front polarizer 820 may be different.

According to certain embodiments disclosed herein, at least a portion of the ambient light may be blocked (e.g., absorbed, reflected, or scattered) by a color filter or a light dimming element before it may be focused onto the display panel by the display optics of a near-eye display to form a local hot spot having a high energy in a small area, which otherwise could cause damages to components of the near-eye display, such as a front polarizer of an LCD display panel of the near-eye display. The color filter or light dimming element may have minimum or no effect on the viewing of the displayed images by the user during normal use of the near-eye display. For example, the ambient light may be blocked by bandpass filters that may block light outside of the light emission spectra of the display panel, or may be blocked by electrically switchable layers that may be switched off to block light when ethe near-eye display is not in use and may be switched on to allowed the display light to pass through when the near-eye display is in use.

In one example, a near-eye display system disclosed herein may include an absorptive color filter coated on a lens of the display optics or another substrate of the near-eye display system. The absorptive color filter may include multiple (e.g., three or more) passbands that match the wavelength bands of the light (e.g., red, green, and blue light) emitted by the image source (e.g., display panel) of the near-eye display. The absorptive color filter may only allow light in the passbands to pass through and may absorb light in other wavelength bands. In this way, display light from the image source of the near-eye display may pass through the absorptive color filter with little or no loss, while only a fraction (e.g., less than about 50%) of the ambient light may be allowed to pass through the absorptive color filter. Therefore, when the near-eye display is in use, most or all display light reaching the absorptive color filter from the image source may pass through the absorptive color filter to reach the user's eye. When the near-eye display is not in use, only a fraction of the light from the ambient environment may be focused by the display optics onto the display panel. The resultant focused light may have a low intensity and thus may not damage the components of the near-eye display.

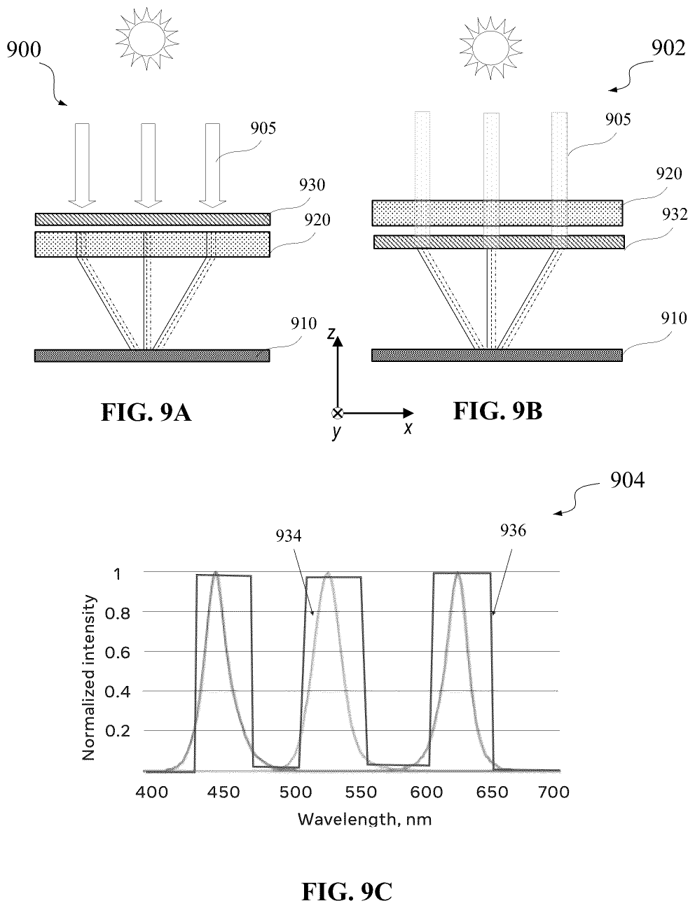

FIG. 9A illustrates an example of a near-eye display 900 including an absorptive color filter 930 according to certain embodiments. As near-eye display 800, near-eye display 900 may include a display panel 910 and display optics 920, where a distance between display panel 910 and display optics 920 may be close to the focal length of display optics 920, such that light emitted by each pixel of display panel 910 may be collimated by display optics 920. In some examples, display panel 910 may be similar to display panel 802, whereas display optics 920 may be similar to display optics 804. Display optics 920 may include a lens or a lens assembly that includes one or more lenses. For example, display optics 920 may include a pancake lens, a Fresnel lens, and the like. In some examples, display optics 920 may include a curved surface.

In the example shown in FIG. 9A, near-eye display 900 may include absorptive color filter 930 on a side of display optics 920 opposing display panel 910. In some examples, absorptive color filter 930 may be formed on a surface of a lens of display optics 920. In some examples, absorptive color filter 930 may be formed on a surface of another substrate. Absorptive color filter 930 may include one or more layers, and the transmission spectra of absorptive color filter 930 may match the light emission spectra of display panel 910. For example, absorptive color filter 930 may have multiple passbands in the visible wavelength range, such as a passband in the red light wavelength range, a passband in the green light wavelength range, and a passband in the blue light wavelength range. Absorptive color filter 930 may absorb light outside of the multiple passbands. Due to the matching between the transmission spectra of absorptive color filter 930 and the light emission spectra of display panel 910, display light emitted by display panel 910 may pass through absorptive color filter 930 with little or no loss.

When near-eye display 900 is not in use (e.g., not mounted on a user's head), ambient light 905 may be incident on absorptive color filter 930 from a side of display optics 920 opposing display panel 910. Thus, ambient light 905 may first be absorbed by absorptive color filter 930, where light outside of the passbands of absorptive color filter 930 may be at least partially absorbed. Therefore, the intensity of the light passing through absorptive color filter 930 may be reduced, for example, by about 50% or higher. The ambient light passing through absorptive color filter 930 may mainly include light in a few wavelength ranges, such as red light, green light, and blue light. As such, the light spot focused onto display panel 910 by display optics 920 may have a much lower power in each unit area, and thus may not damage display panel 910, such as a front polarizer (e.g., front polarizer 820) of display panel 910.

FIG. 9B illustrates another example of a near-eye display 902 including an absorptive color filter 932 according to certain embodiments. Near-eye display 902 may also include display panel 910 and display optics 920 as described above with respect to near-eye display 900. In the example shown in FIG. 9B, near-eye display 902 may include absorptive color filter 932 on a same side of display optics 920 as display panel 910. In some examples, absorptive color filter 932 may be formed on a surface of a lens of display optics 920. In some examples, absorptive color filter 932 may be formed on a surface of another substrate. As absorptive color filter 930, absorptive color filter 932 may include one or more layers, and the transmission spectra of absorptive color filter 932 may match the light emission spectra of display panel 910. For example, absorptive color filter 932 may have multiple passbands in the visible wavelength range, such as a passband in the red light wavelength range, a passband in the green light wavelength range, and a passband in the blue light wavelength range. Absorptive color filter 932 may absorb light outside of the multiple passbands. Due to the matching between the transmission spectra of absorptive color filter 932 and the light emission spectra of display panel 910, display light emitted by display panel 910 may pass through absorptive color filter 932 with little or no loss.

When near-eye display 902 is not in use (e.g., placed on a table rather than mounted on a user's head), ambient light 905 may be incident on absorptive color filter 932 from the side of display optics 920. Thus, ambient light 905 may be absorbed by absorptive color filter 932 before ambient light has been focused onto display panel 910, while light outside of the passbands of absorptive color filter 932 may be at least partially absorbed. Therefore, the intensity of the light passing through absorptive color filter 932 and continuing to be focused onto display panel 910 may be reduced, for example, by about 50% or higher. The ambient light passing through absorptive color filter 932 may mainly include light in a few wavelength ranges, such as red light, green light, and blue light. As such, the light spot focused onto display panel 910 may have a much lower power in each unit area, and thus may not damage display panel 910, such as a front polarizer (e.g., front polarizer 820) of display panel 910.

Even though not shown in FIGS. 9A and 9B, in some examples, a near-eye display may include two or more absorptive color filters on two or more surfaces of display optics 920, and/or on another component (e.g., a substrate) between display optics 920 and display panel 910, where the two or more absorptive color filters may absorb ambient light outside of the passbands before the ambient light is focused into a small light spot having a high intensity.

FIG. 9C includes a diagram 904 illustrating an example of the transmission spectra of an absorptive color filter of FIG. 9A or 9B. In diagram 904, the horizontal axis corresponds to the wavelength of incident light, and the vertical axis corresponds to the normalized transmissivity or intensity of the transmitted light. A curve 934 in diagram 904 shows the light emission spectra of display panel 910, which may have three peaks in the red, green, and blue light wavelength ranges, respectively. The intensities of the red, green, and blue light emitted from each pixel may be controlled to provide the desired color gamut and brightness.

A curve 936 in FIG. 9C shows an example of the transmission spectra of absorptive color filter 930 or 932. As illustrated, absorptive color filter 930 or 932 may have three passbands in the red, green, and blue light wavelength ranges, respectively. The peaks of the light emission spectra of display panel 910 may fall within the passbands of absorptive color filter 930 or 932. The width of each passband of absorptive color filter 930 or 932 may be selected to balance the absorption of the display light by absorptive color filter 930 or 932, and the absorption of ambient light by absorptive color filter 930 or 932. For example, a wider passband may reduce the absorption of the display light by absorptive color filter 930 or 932 (and thus allow more display light to reach the user's eye), but may also reduce the absorption of ambient light by absorptive color filter 930 or 932 (and thus may increase the possibility of damaging display panel 910).

The absorptive color filter can be formed on one or more (e.g., top and/or bottom) surfaces of the display optics (e.g., a lens such as a pancake lens or Fresnel lens) or another substate by, for example, depositing chromatic or dye materials with different peak absorption wavelength ranges on one or more surfaces of a lens assembly. The chromatic or dye materials may be selected such that the transmission spectra of the absorptive filter may match the light emission spectra of the image source (e.g., display panel) as shown in FIG. 9C, such that the absorptive color filter may absorb little or no display light from display panel 910.

In another example of the near-eye display disclosed herein, the near-eye display may include a reflective color filter formed one or more surfaces of the display optics, another substrate, or a surface of the display panel. The reflective color filter may include multiple (e.g., three or more) passbands that match the wavelength bands of the light (e.g., red, green, and blue light) emitted by the display panel of the near-eye display. The reflective color filter may only allow light in the passbands to pass through and may reflect light in other wavelength bands. In this way, display light from the display panel may pass through the reflective color filter with little or no loss to reach the user's eye, while a large portion (e.g., greater than about 50%) of the ambient light may be reflected by the reflective color filter before or after the ambient light is focused by the display optics. Therefore, when the near-eye display is in use, most or all display light reaching the reflective color filter from the display panel may pass through the reflective color filter to reach the user's eye. When the near-eye display is not in use, only a fraction of the light from the ambient environment may pass through the reflective color filter and be focused by the display optics onto the display panel. The reflective color filter can be formed on one or more (e.g., top and/or bottom) surfaces of the display optics (e.g., a lens such as a pancake lens or a Fresnel lens), another substrate, or a surface of the display panel.

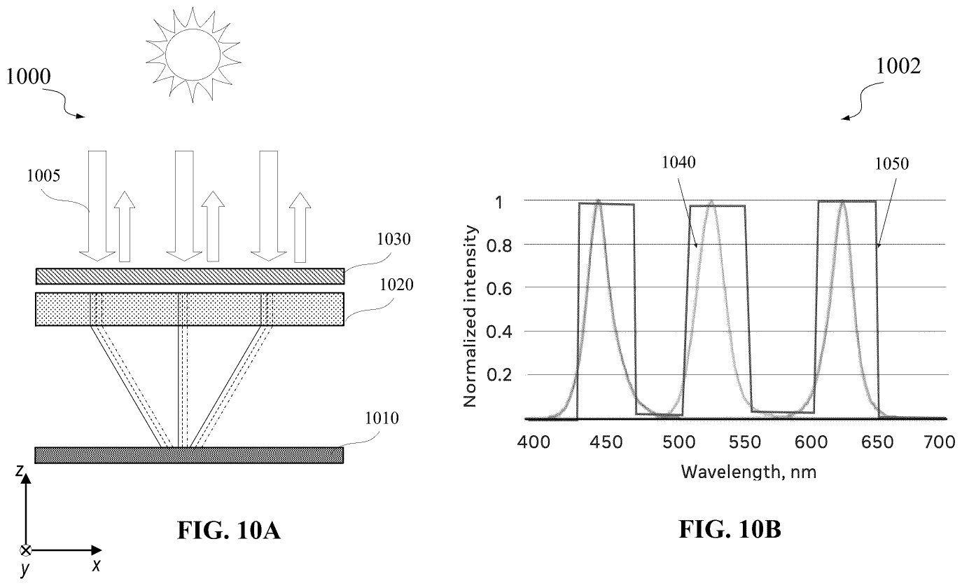

FIG. 10A illustrates an example of a near-eye display 1000 including an reflective color filter according to certain embodiments. As near-eye display 800 or 900, near-eye display 1000 may include a display panel 1010 and display optics 1020, where a distance between display panel 1010 and display optics 1020 may be close to the focal length of display optics 1020, such that light emitted by each pixel of display panel 1010 may be collimated by display optics 1020. In some examples, display panel 1010 may be similar to display panel 802, whereas display optics 1020 may be similar to display optics 804. Display optics 1020 may be similar to display optics 920 and may include a lens or a lens assembly that includes one or more lenses. In some examples, display optics 1020 may include a curved surface.

In the example shown in FIG. 10A, near-eye display 1000 may include reflective color filter 1030 on a side of display optics 1020 opposing display panel 1010. In some examples, reflective color filter 1030 may be formed on a surface of a lens of display optics 1020. In some examples, reflective color filter 1030 may be formed on a surface of another substrate. Reflective color filter 1030 may include one or more layers, and the transmission spectra of reflective color filter 1030 may match the light emission spectra of display panel 1010. For example, reflective color filter 1030 may have multiple passbands in the visible wavelength range, such as a passband in the red light wavelength range, a passband in the green light wavelength range, and a passband in the blue light wavelength range. Reflective color filter 1030 may reflect light outside of the multiple passbands. Due to the matching between the transmission spectra of reflective color filter 1030 and the light emission spectra of display panel 1010, display light emitted by display panel 1010 may pass through reflective color filter 1030 with little or no loss before reaching the user's eye.

When near-eye display 1000 is not in use (e.g., placed on a table rather than mounted on a user's head), ambient light 1005 may be incident on reflective color filter 1030 from a side of display optics 1020 opposing display panel 1010. Thus, ambient light 1005 outside of the passbands of reflective color filter 1030 may be at least partially reflected back to the ambient environment. Therefore, the intensity of the light passing through reflective color filter 1030 may be reduced, for example, by about 50% or higher. The ambient light passing through reflective color filter 1030 may mainly include light in a few wavelength ranges, such as red light, green light, and blue light. As such, the light spot focused onto display panel 1010 by display optics 1020 may have a much lower power in each unit area, and thus may not damage display panel 1010, such as a front polarizer of display panel 1010.

In some examples, reflective color filter 1030 may be between display panel 1010 and display optics 1020, such as on a surface of display optics 1020 facing display panel 1010, or on a surface of a substrate between display panel 1010 and display optics 1020. In some examples, reflective color filter 1030 may be formed on a surface of display panel 1010 facing display optics 1020. Even though not shown in FIG. 10A, in some examples, a second color filter, such as an absorptive color filter described above, may be formed on a side of display optics 1020 opposing reflective color filter 1030, or between display panel 1010 and display optics 1020. The second color filter may further block (e.g., reflect, scatter, or absorb) ambient light outside of the passbands of reflective color filter 1030 but passed through reflective color filter 1030 due to, for example, a transmissivity greater than 0% in the stop bands of reflective color filter 1030.

FIG. 10B includes a diagram 1002 illustrating an example of the transmission spectra of the reflective color filter of FIG. 10A. In diagram 1002, the horizontal axis corresponds to the wavelength of incident light, and the vertical axis corresponds to the normalized transmissivity or intensity of the transmitted light of reflective color filter 1030. A curve 1040 in diagram 1002 shows the light emission spectra of display panel 1010, which may have three peaks in the red, green, and blue light wavelength ranges. The intensities of the red, green, and blue light emitted by each pixel may be controlled to provide the desired color gamut and brightness.

A curve 1050 in FIG. 10B shows an example of the transmission spectra of reflective color filter 1030. As illustrated, reflective color filter 1030 may have three passbands in the red, green, and blue light wavelength ranges, respectively. The peaks of the light emission spectra of display panel 1010 may fall within the passbands of reflective color filter 1030. The width of each passband of reflective color filter 1030 may be selected to balance the reflection of the display light and the ambient light by reflective color filter 1030. For example, a wider passband may reduce the reflection of the display light by reflective color filter 1030 (and thus allow more display light to reach user's eye), but may also reduce the reflection of ambient light by reflective color filter 1030 (and thus may increase the possibility of damaging display panel 1010).

Reflective color filter 1030 with multiple passbands may include, for example, a plurality of dielectric layers with different refractive indices and coated on one or more surfaces of the display optics (e.g., a lens assembly) or another substrate by, for example, vapor deposition or other coating or deposition techniques. The refractive indices and/or the thicknesses of the plurality of dielectric layers may be selected such that the transmission spectra of the reflective color filter may match the light emission spectra of the image source (e.g., display panel) as shown in FIG. 10B, and thus the reflective color filter may reflect minimum or no display light from display panel 1010.

In yet another example disclosed herein, a near-eye display may additionally or alternatively include one or more electrically switchable films formed on one or more surfaces of the display optics (e.g., a lens assembly) or another substrate. The electrically switchable films, when switched off, may reflect, absorb, and/or scatter incident light. When switched on (e.g., in a normal or default operation mode), the electrically switchable films may allow most or all display light to pass through and reach user's eye. When the near-eye display is not in use, the electrically switchable films may be switched off to reflect, absorb, and/or scatter most or all incident light (e.g., sunlight), thereby protecting the image source (e.g., display panel) from being damaged by ambient light. The one or more electrically switchable films may be formed on one or more (e.g., top and/or bottom) surfaces of the display optics (e.g., a lens such as a pancake lens or a Fresnel lens) or another substrate.

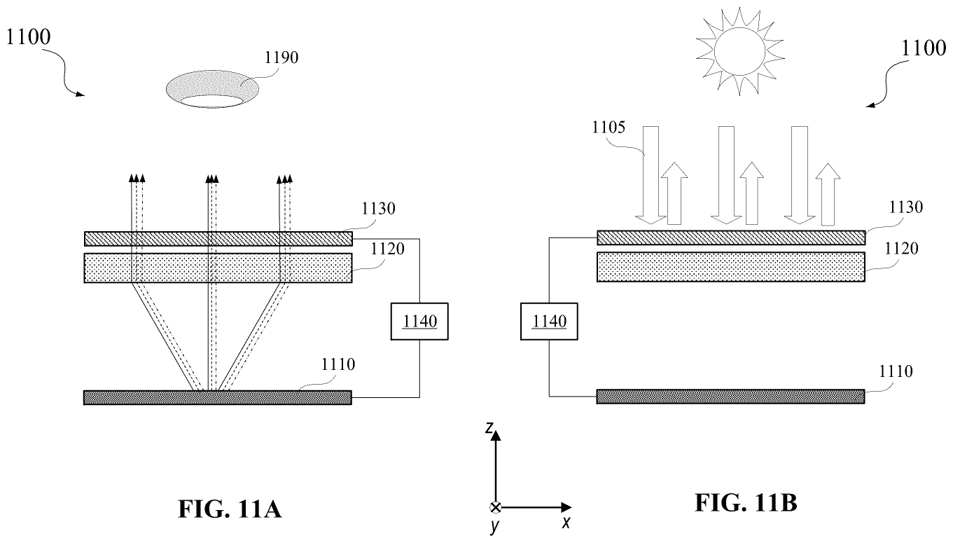

FIGS. 11A and 11B illustrate an example of a near-eye display 1100 including an electrically switchable layer 1130 according to certain embodiments. As near-eye displays 800, 900, and 1000, near-eye display 1100 may include a display panel 1110 and display optics 1120, where a distance between display panel 1110 and display optics 1120 may be close to the focal length of display optics 1120, such that light emitted by each pixel of display panel 1110 may be collimated by display optics 1120. In some examples, display panel 1110 may be similar to display panel 802 (e.g., including an LCD, OLED, or LED based display), whereas display optics 1120 may be similar to display optics 804. Display optics 1120 may include a lens or a lens assembly that includes one or more lenses, such as a pancake lens or Fresnel lens. In some examples, display optics 1120 may include a curved surface.

In the illustrated example, near-eye display 1100 may include electrically switchable layer 1130 on a side of display optics 1120 opposing display panel 1110. In some examples, electrically switchable layer 1130 may be formed on a surface of a lens of display optics 1120. In some examples, electrically switchable layer 1130 may be formed on a surface of another substrate. In some examples, two or more electrically switchable layers 1130 may be formed on two or more surfaces of display optics 1120. Electrically switchable layer 1130 may be tuned on to allow incident light to pass through, and may be turned off to block (e.g., absorb, reflect, and/or scatter) incident light. In some examples, electrically switchable layer 1130 may be normally off when no voltage signal is applied to electrically switchable layer 1130, and may be turned on when a voltage signal is applied to electrically switchable layer 1130. In some examples, electrically switchable layer 1130 may be normally on when no voltage signal is applied to electrically switchable layer 1130, and may be turned off when a voltage signal is applied to electrically switchable layer 1130. For example, near-eye display 1100 may include a controller 1140 that can provide control signals to turn on or off electrically switchable layer 1130. In some examples, controller 1140 may also control display panel 1110 or may be electrically coupled to display panel 1110 or a controller for display panel 1110. In one example, controller 1140 may turn on electrically switchable layer 1130 when display panel 1110 is turned on or when a user's eye is detected by a sensor such as a proximity sensor or an eye-tracking system (and thus near-eye display 1100 may be in use), and controller 1140 may turn off electrically switchable layer 1130 when display panel 1110 is turned off or the user's eye is not detected by the proximity sensor or eye-tracking system (and thus near-eye display 1100 may not be mounted on the user's head).

FIG. 11A shows an example of a normal operation of near-eye display 1100. When near-eye display 1100 is in use, light of different colors emitted by each pixel of display panel 1110 may be collimated by display optics, such that the image displayed by display panel 1110 may appear to be far away from the user. The collimated display light may be incident on electrically switchable layer 1130, which may be turned on to allow incident light to pass through in the normal operation of near-eye display 1100. Therefore, the display light may be received by the user's eye 1190, which may focus the display light from each pixel of display panel 1110 to form an image on the retina of the user's eye 1190.

FIG. 11B shows an example where near-eye display 1100 is unused in an outdoor environment. When near-eye display 1100 is not in use (e.g., not mounted on a user's head), electrically switchable layer 1130 may be tuned off such that incident light may be reflected, absorbed, scattered, or otherwise blocked by electrically switchable layer 1130. Therefore, ambient light 1105 (e.g., sunlight) incident on electrically switchable layer 1130 from a side of display optics 1120 opposing display panel 1110 may be blocked by electrically switchable layer 1130 and may not reach display optics 1120. In some examples, electrically switchable layer 1130 may be dimmable, such that the transmissivity of electrically switchable layer 1130 may be tuned by changing the applied control signal (e.g., voltage level).

Electrically switchable layer 1130 may include a reflective type electrically switchable film (e.g., including a cholesterol liquid crystal film), a light scattering type electrically switchable film (e.g., including a polymer-dispersed liquid crystal film), or an absorption type electrically switchable film (e.g., including an electrochromic film or a dye doped liquid crystal film). In one example, electrically switchable layer 1130 may include an LC material layer that can be tuned by applying an electrical field to change the orientations of the LC molecules, thus changing the transmission rate of the LC material layer. For example, electrically switchable layer 1130 may be implemented using a polymer-dispersed liquid crystal (PDLC) device, a guest-host liquid crystal device, a polymer-stabilized cholesteric texture liquid crystal device, a dye doped liquid crystal device, a liquid crystal device with suspended nano-particles, and the like. In some implementations, electrically switchable layer 1130 may include an electrochromic device (e.g., including tungsten trioxide (WO3)) or a photochromic device.

In one example, electrically switchable layer 1130 may include two substrates with coated transparent electrode layers. The substrates may be part of display optics 1120 or may be other substrates not within display optics 1120. The substrates may form a cavity that can hold a PDLC mixture including liquid crystal molecules and polymers. The concentration of polymers in the mixture may be, for example, about 30% to 50%. The polymers may be cured within the LC/polymer emulsion to form a polymer matrix. Droplets of liquid crystal molecules may be separated by the polymer matrix. When a voltage signal is not applied to the transparent electrode layers, liquid crystal molecules within each droplet may have a localized order, but different droplets may be randomly aligned relative to others. Thus, the incident light may be randomly scattered by the liquid crystal molecules and hence electrically switchable layer 1130 may be turned off (being opaque). When a voltage signal is applied to the transparent electrode layers, electro-optic reorientation of the liquid crystal droplets may occur, which may reduce the degree of optical scattering through the liquid crystal cell. Thus, electrically switchable layer 1130 may be turned on (being transparent). In some embodiments, chemical dyes can be added to the PDLC mixtures. The chemical dyes may preferentially scatter or absorb light of certain wavelengths.

In another example, electrically switchable layer 1130 may be a switchable guest-host liquid crystal device. A guest-host liquid crystal device may include two substrates forming a cavity that hold a mixture including liquid crystal molecules and dyes (e.g., dichroic dyes). Positive dichroic dyes may generally absorb light with electrical field along the long axis of the dichroic dye. Negative dichroic dyes may absorb light with electrical field perpendicular to the long axis of the dye. When the LC molecules in the mixture change their orientations, the dichroic dyes may also change the orientations along with the LC molecules. As such, the absorption axis may be changing, and the light transmission can be modulated. In one example, the liquid crystal molecules may have a homogeneous alignment, the liquid crystal molecules and thus the dyes may have a planar alignment when no voltage is applied. When unpolarized light is incident on the guest-host liquid crystal device, it may be linearly polarized by a linear polarizer with a polarization direction aligned with the absorption axis of the dye. Therefore, the polarized light may be absorbed by the dyes and the guest-host liquid crystal device may be turned off (being opaque), when no voltage signal is applied. When a voltage is applied to the guest-host liquid crystal device, the LC director may rotate to a homeotropic orientation, and thus the absorption due to the dyes may decrease because the long absorption axes of the dyes may be perpendicular to the direction of polarization of light. Thus, the guest-host liquid crystal device may be turned on (being transparent) when a voltage signal is applied. In some embodiments, the guest-host liquid crystal device may be a phase change guest-host (PC-GH) liquid crystal device, which may be a light reflective electrically switchable device.

In yet another example, electrically switchable layer 1130 may include a switchable polymer-stabilized cholesteric texture (PSCT) liquid crystal device. The PSCT LC device may include two substrates and a mixture of monomers and cholesteric liquid crystals between the two substrates. Polymerization may occur when a high voltage is applied to the transparent electrode layers formed on the substrates. The polymerization may tend to unwind the cholesteric structure of the cholesteric texture liquid crystals and reorients the LC molecules to the homeotropic state (e.g., perpendicular to the substrate). After polymerization, a liquid crystal cell with a polymer network perpendicular to the substrates may be formed. When a voltage signal is not applied to the transparent electrode layers, the LC molecules may have a helical structure, while the polymer network may try to keep the LC director parallel to the polymer network. The competition between these two factors may result in a focal conic texture. Thus, the liquid crystal cell may have a poly-domain structure and may be optically scattering (in the off or opaque state). When a sufficiently high electric field is applied across the liquid crystal cell, the LC molecules may be switched to the homeotropic texture. Thus, incident light may only see the ordinary reflective index of the LC molecules and may not be scattered. Therefore, the liquid crystal cell is transparent and the PSCT LC device may be turned on to transmit light. Because the concentration of the polymer may be low and both the LC and the polymer may be aligned in a direction perpendicular to the substrate, the PSCT LC device may be transparent at a wide range of viewing angles.

In another example, electrically switchable layer 1130 may be a cholesteric liquid crystal device including chiral nematic LC or nematic LC with addition of chiral agent. The cholesteric liquid crystal device may be made to reflect light in a certain wavelength range by Bragg reflection. When the helical twist of the cholesteric liquid crystals aligns along the surface normal direction of the substrate, a planar or Grandjean texture may be obtained to reflect circularly polarized light having the same sense or handedness as the helical twist, and thus the cholesteric liquid crystal device may be turned off (being opaque). When a voltage signal is applied to the cholesteric liquid crystal device, a focal conic domain configuration may be obtained, and the cholesteric liquid crystal device may not reflect incident light and may thus be turned on (being transparent).

It is noted that LC composite materials suitable for use in the electrically switching layers are not limited to the ones described in the above examples. For example, other LC composite materials having electrically controllable light scattering effect may include reversed scattering mode PDLCs, LC cells operating in dynamic scattering mode, LC filled with nanoparticles, twisted nematic liquid crystal cell, and the like.

In addition, in some examples, a near-eye display may include a combination of the absorptive color filter, reflective color filter, and/or electrically switchable film described above. For example, one absorptive color filter, reflective color filter, or electrically switchable film may be formed on one surface of display optics 1120 (or another substrate), whereas another absorptive color filter, reflective color filter, or electrically switchable film may be formed on another surface of display optics 1120 (or another substrate) of the near-eye display.

Embodiments disclosed herein may be used to implement components of an artificial reality system or may be implemented in conjunction with an artificial reality system. Artificial reality is a form of reality that has been adjusted in some manner before presentation to a user, which may include, for example, a virtual reality, an augmented reality, a mixed reality, a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including an HMD connected to a host computer system, a standalone HMD, a mobile device or computing system, or any other hardware platform capable of providing artificial reality content to one or more viewers.

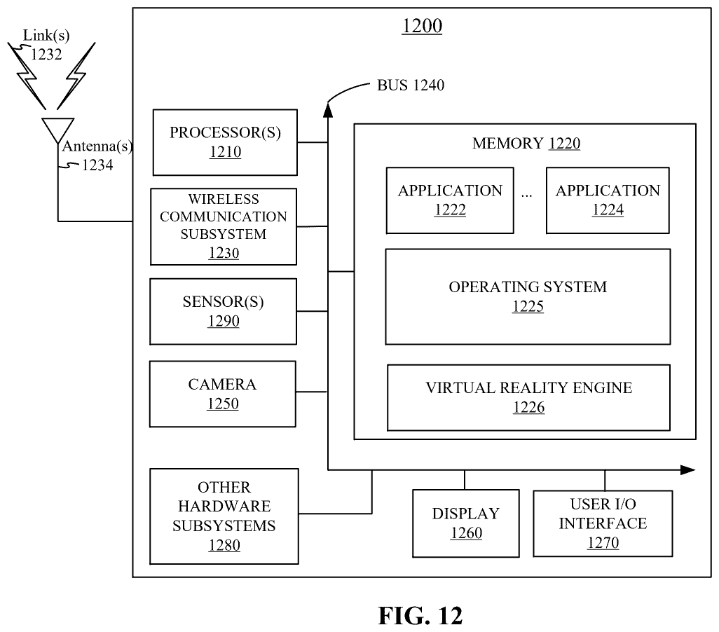

FIG. 12 is a simplified block diagram of an example of an electronic system 1200 of an example of a near-eye display (e.g., HMD device) for implementing some examples disclosed herein. Electronic system 1200 may be used as the electronic system of an HMD device or other near-eye displays described above. In this example, electronic system 1200 may include one or more processor(s) 1210 and a memory 1220. Processor(s) 1210 may be configured to execute instructions for performing operations at a number of components, and can be, for example, a general-purpose processor or microprocessor suitable for implementation within a portable electronic device. Processor(s) 1210 may be communicatively coupled with a plurality of components within electronic system 1200. To realize this communicative coupling, processor(s) 1210 may communicate with the other illustrated components across a bus 1240. Bus 1240 may be any subsystem adapted to transfer data within electronic system 1200. Bus 1240 may include a plurality of computer buses and additional circuitry to transfer data.

Memory 1220 may be coupled to processor(s) 1210. In some embodiments, memory 1220 may offer both short-term and long-term storage and may be divided into several units. Memory 1220 may be volatile, such as static random access memory (SRAM) and/or dynamic random access memory (DRAM) and/or non-volatile, such as read-only memory (ROM), flash memory, and the like. Furthermore, memory 1220 may include removable storage devices, such as secure digital (SD) cards. Memory 1220 may provide storage of computer-readable instructions, data structures, program code, and other data for electronic system 1200. In some embodiments, memory 1220 may be distributed into different hardware subsystems. A set of instructions and/or code might be stored on memory 1220. The instructions might take the form of executable code that may be executable by electronic system 1200, and/or might take the form of source and/or installable code, which, upon compilation and/or installation on electronic system 1200 (e.g., using any of a variety of generally available compilers, installation programs, compression/decompression utilities, etc.), may take the form of executable code.

In some embodiments, memory 1220 may store a plurality of applications 1222 through 1224, which may include any number of applications. Examples of applications may include gaming applications, conferencing applications, video playback applications, or other suitable applications. The applications may include a depth sensing function or eye tracking function. Applications 1222-1224 may include particular instructions to be executed by processor(s) 1210. In some embodiments, certain applications or parts of applications 1222-1224 may be executable by other hardware subsystems 1280. In certain embodiments, memory 1220 may additionally include secure memory, which may include additional security controls to prevent copying or other unauthorized access to secure information.

In some embodiments, memory 1220 may include an operating system 1225 loaded therein. Operating system 1225 may be operable to initiate the execution of the instructions provided by applications 1222-1224 and/or manage other hardware subsystems 1280 as well as interfaces with a wireless communication subsystem 1230 which may include one or more wireless transceivers. Operating system 1225 may be adapted to perform other operations across the components of electronic system 1200 including threading, resource management, data storage control and other similar functionality.

Wireless communication subsystem 1230 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 1200 may include one or more antennas 1234 for wireless communication as part of wireless communication subsystem 1230 or as a separate component coupled to any portion of the system. Depending on desired functionality, wireless communication subsystem 1230 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. Wireless communications subsystem 1230 may permit data to be exchanged with a network, other computer systems, and/or any other devices described herein. Wireless communication subsystem 1230 may include a means for transmitting or receiving data, such as identifiers of HMD devices, position data, a geographic map, a heat map, photos, or videos, using antenna(s) 1234 and wireless link(s) 1232.

Embodiments of electronic system 1200 may also include one or more sensors 1290. Sensor(s) 1290 may include, for example, an image sensor, an accelerometer, a pressure sensor, a temperature sensor, a proximity sensor, a magnetometer, a gyroscope, an inertial sensor (e.g., a subsystem that combines an accelerometer and a gyroscope), an ambient light sensor, or any other similar devices or subsystems operable to provide sensory output and/or receive sensory input, such as a depth sensor or a position sensor. For example, in some implementations, sensor(s) 1290 may include one or more inertial measurement units (IMUs) and/or one or more position sensors. An IMU may generate calibration data indicating an estimated position of the HMD device relative to an initial position of the HMD device, based on measurement signals received from one or more of the position sensors. A position sensor may generate one or more measurement signals in response to motion of the HMD device. Examples of the position sensors may include, but are not limited to, one or more accelerometers, one or more gyroscopes, one or more magnetometers, another suitable type of sensor that detects motion, a type of sensor used for error correction of the IMU, or some combination thereof. The position sensors may be located external to the IMU, internal to the IMU, or some combination thereof. At least some sensors may use a structured light pattern for sensing.

Electronic system 1200 may include a display 1260. Display 1260 may be a near-eye display, and may graphically present information, such as images, videos, and various instructions, from electronic system 1200 to a user. Such information may be derived from one or more applications 1222-1224, virtual reality engine 1226, one or more other hardware subsystems 1280, a combination thereof, or any other suitable means for resolving graphical content for the user (e.g., by operating system 1225). Display 1260 may use liquid crystal display (LCD) technology, light emitting diode (LED) technology (including, for example, OLED, ILED, μLED, AMOLED, TOLED, etc.), light emitting polymer display (LPD) technology, or some other display technology.

Electronic system 1200 may include a user input/output interface 1270. User input/output interface 1270 may allow a user to send action requests to electronic system 1200. An action request may be a request to perform a particular action. For example, an action request may be to start or end an application or to perform a particular action within the application. User input/output interface 1270 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 1200. In some embodiments, user input/output interface 1270 may provide haptic feedback to the user in accordance with instructions received from electronic system 1200. For example, the haptic feedback may be provided when an action request is received or has been performed.

Electronic system 1200 may include a camera 1250 that may be used to take photos or videos of a user, for example, for tracking the user's eye position. Camera 1250 may also be used to take photos or videos of the environment, for example, for VR, AR, or MR applications. Camera 1250 may include, for example, a complementary metal-oxide-semiconductor (CMOS) image sensor with a few millions or tens of millions of pixels. In some implementations, camera 1250 may include two or more cameras that may be used to capture 3-D images.

In some embodiments, electronic system 1200 may include a plurality of other hardware subsystems 1280. Each of other hardware subsystems 1280 may be a physical subsystem within electronic system 1200. While each of other hardware subsystems 1280 may be permanently configured as a structure, some of other hardware subsystems 1280 may be temporarily configured to perform specific functions or temporarily activated. Examples of other hardware subsystems 1280 may include, for example, an audio output and/or input interface (e.g., a microphone or speaker), a near field communication (NFC) device, a rechargeable battery, a battery management system, a wired/wireless battery charging system, etc. In some embodiments, one or more functions of other hardware subsystems 1280 may be implemented in software.

In some embodiments, memory 1220 of electronic system 1200 may also store a virtual reality engine 1226. Virtual reality engine 1226 may execute applications within electronic system 1200 and receive position information, acceleration information, velocity information, predicted future positions, or some combination thereof of the HMD device from the various sensors. In some embodiments, the information received by virtual reality engine 1226 may be used for producing a signal (e.g., display instructions) to display 1260. For example, if the received information indicates that the user has looked to the left, virtual reality engine 1226 may generate content for the HMD device that mirrors the user's movement in a virtual environment. Additionally, virtual reality engine 1226 may perform an action within an application in response to an action request received from user input/output interface 1270 and provide feedback to the user. The provided feedback may be visual, audible, or haptic feedback. In some implementations, processor(s) 1210 may include one or more GPUs that may execute virtual reality engine 1226.

In various implementations, the above-described hardware and subsystems may be implemented on a single device or on multiple devices that can communicate with one another using wired or wireless connections. For example, in some implementations, some components or subsystems, such as GPUs, virtual reality engine 1226, and applications (e.g., tracking application), may be implemented on a console separate from the head-mounted display device. In some implementations, one console may be connected to or support more than one HMD.

In alternative configurations, different and/or additional components may be included in electronic system 1200. Similarly, functionality of one or more of the components can be distributed among the components in a manner different from the manner described above. For example, in some embodiments, electronic system 1200 may be modified to include other system environments, such as an AR system environment and/or an MR environment.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” may refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms “and” and “or,” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or any combination of A, B, and/or C, such as AB, AC, BC, AA, ABC, AAB, AABBCCC, or the like.

In this description, the recitation “based on” means “based at least in part on.” Therefore, if X is based on Y, then X may be a function of at least a part of Y and any number of other factors. If an action X is “based on” Y, then the action X may be based at least in part on at least a part of Y.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different time.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A near-eye display system comprising:
a display panel configured to generate a display image;
display optics configured to project the display image to a user's eye; and
a color filter on a side of the display optics opposing the display panel, wherein transmission spectra of the color filter match light emission spectra of the display panel.

2. The near-eye display system of claim 1, wherein the display panel includes a liquid crystal display panel, an organic light emitting diode display panel, or a light emitting diode display panel.

3. The near-eye display system of claim 1, wherein the display optics include a lens or a lens assembly.

4. The near-eye display system of claim 1, wherein the color filter is formed on a surface of the display optics or a surface of a substrate.

5. The near-eye display system of claim 1, wherein the color filter includes a plurality of passbands and a plurality of stopbands.

6. The near-eye display system of claim 1, wherein the color filter includes a reflective color filter or an absorptive color filter.

7. The near-eye display system of claim 6, wherein the reflective color filter comprises a plurality of dielectric layers having two or more different refractive indices.

8. The near-eye display system of claim 6, wherein the absorptive color filter comprises chromatic or dye materials having different peak absorption wavelength ranges.

9. The near-eye display system of claim 1, further comprising a second color filter on a same side of the display optics as the display panel.

10. The near-eye display system of claim 1, wherein the display panel is on a focal plane of the display optics such that the display optics collimate light emitted by each pixel of the display panel.

11. A near-eye display system comprising:
a display panel configured to generate a display image;
display optics configured to project the display image to a user's eye; and
a color filter between the display optics and the display panel, wherein transmission spectra of the color filter match light emission spectra of the display panel.

12. The near-eye display system of claim 11, wherein:
the color filter includes an absorptive color filter; and
the color filter is on a surface of the display optics or a surface of a substrate at a distance from the display panel.

13. The near-eye display system of claim 11, wherein:
the color filter includes a reflective color filter; and
the color filter is on a surface of the display optics, a surface of a substrate at a distance from the display panel, or a surface of the display panel facing the display optics.

14. A near-eye display system comprising:
a display panel configured to generate a display image;
display optics configured to project the display image to a user's eye;
an electrically switchable layer on a side of the display optics opposing the display panel, or between the display optics and the display panel and at a distance from the display panel; and
a controller configured to turn on or turn off the electrically switchable layer.

15. The near-eye display system of claim 14, wherein the controller is configured to:
turn on the electrically switchable layer when the display panel is turned on or when the user's eye is detected by a sensor, such that the display image is viewable by the user's eye through the electrically switchable layer; and
turn off the electrically switchable layer to at least partially block ambient light from reaching the display panel, when the display panel is turned off or when the user's eye is not detected.

16. The near-eye display system of claim 14, wherein the display panel includes a liquid crystal display panel, an organic light emitting diode display panel, or a light emitting diode display panel.

17. The near-eye display system of claim 14, further comprising a color filter on the side of the display optics opposing the display panel, or between the display optics and the display panel, wherein transmission spectra of the color filter match light emission spectra of the display panel.

18. The near-eye display system of claim 14, wherein the electrically switchable layer includes a switchable reflective film, a switchable light absorption film, a switchable light scattering film, or a combination thereof.

19. The near-eye display system of claim 14, wherein the electrically switchable layer includes:
a guest-host liquid crystal device;
a polymer-dispersed liquid crystal device;
a cholesteric liquid crystal device
a polymer-stabilized cholesteric texture liquid crystal device;
a dye-doped liquid crystal device;
a liquid crystal device with suspended nano-particles;
an electrochromic layer;
a photochromatic layer; or
a combination thereof.

20. The near-eye display system of claim 14, wherein the electrically switchable layer is formed on a surface of the display optics or a substrate.
